(19) United States
(12) Patent Application Publication
(10) Pub. No.: US 2026/0159243 A1
(43) Pub. Date: Jun. 11, 2026

(54) ASSEMBLY OF AN ENGINE MOUNTING PYLON WITH AN AIRCRAFT ENGINE

(71) Applicant: Airbus Operations SAS, TOULOUSE (FR)

(72) Inventors: Michael BERJOT, TOULOUSE (FR); Jean-Baptiste VIGNES, TOULOUSE (FR); Anton STEFAN, TOULOUSE (FR); Cyril D'ARAUJO, TOULOUSE (FR)

(21) Appl. No.: 19/409,935

(22) Filed: Dec. 5, 2025

(30) Foreign Application Priority Data
Dec. 10, 2024 (FR) 2413792

(51) Int. Cl. B64D 27/40; B64D 27/18

(52) U.S. Cl. CPC B64D 27/402; B64D 27/18; B64D 27/404

(57) ABSTRACT

An assembly of an engine mounting pylon with an aircraft engine, by virtue of a front engine mount rigidly secured to an aircraft primary structure, including a body partially fitted into the primary structure. The body includes, on its front face, a first and second pair of branches. The branches of the two pairs all extend forwards and parallel to the median vertical plane. The body includes a lower face facing the engine and a stud located in the vertical median plane and articulated to the engine, a two-point straight shackle, inserted between the branches of the first pair of branches, being articulated, at one location, to the body via a first pivot pin and, at another location, to the engine via a second pivot pin. Each of the branches of the second pair of branches are articulated to the engine via the second pivot pin.

### CROSS-REFERENCES TO RELATED APPLICATIONS

This application claims the benefit of the French Patent Application No. FR2413792 filed on December 10, 2024, the entire disclosures of which are incorporated herein by way of reference.

### FIELD OF THE INVENTION

The present invention relates to an assembly of an engine mounting pylon with an aircraft engine. The present invention also relates to an aircraft comprising at least one such assembly.

### BACKGROUND OF THE INVENTION

As shown in FIG. 1, an aircraft 10 conventionally comprises, beneath each of its wings 12, at least one engine 14 of jet engine type comprising a fan. Each engine 14 is attached beneath a wing 12 by means of an engine mounting pylon 16 attached, on the one hand, to the wing 12 and, on the other hand, to the engine 14, by means of engine mounts. The engine 14 is surrounded by a nacelle. Conventionally, there is a front engine mount at the front of the engine, and a rear engine mount located at the rear of the engine. The fans of new-generation engines are large, so as to improve the performance of the engines, and this correspondingly reduces the distance between the nacelle of the engine and the ground.

There is therefore a need for the assembly of the engine mounting pylon and the engine to be designed such that it makes it possible to bring the engine closer to the engine mounting pylon in order to maintain an acceptable ground clearance.

### SUMMARY OF THE INVENTION

The invention fully or partly meets this need. To this end, the invention relates to an assembly of an engine mounting pylon with an aircraft engine, the engine extending along a longitudinal axis, the engine mounting pylon comprising a primary structure extending from front to rear along the longitudinal axis, separated into two, port and starboard, parts by a longitudinal median vertical plane passing through the longitudinal axis, the primary structure comprising, at the top, an upper spar, at the bottom, a lower spar located facing the engine, the primary structure comprising a front face having an opening, the assembly comprising, at the rear, a rear engine mount and, at the front, a front engine mount, each of the engine mounts being attached, on the one hand, to the primary structure and, on the other hand, to the engine, wherein the front engine mount comprises a body partially fitted into the primary structure through the opening and extending the primary structure forward, the body comprising on its front face, and from top to bottom, a first pair of branches then a second pair of branches, wherein the spacing between the branches of the second pair of branches is greater than the spacing between the branches of the first pair of branches, wherein the branches of the two pairs of branches all extend forwards and parallel to the median vertical plane, the plane forming a plane of symmetry for each of the two pairs of branches, the body comprising a lower face facing the engine and a stud located in the vertical median plane and extending away from the face, a two-point straight shackle, inserted between the branches of the first pair of branches, being articulated, on the one hand, to the body by means of a first pivot pin and, on the other hand, to the engine by means of a second pivot pin, each of the branches of the second pair of branches being articulated to the engine by means of the second pivot pin, the first and the second pivot pins being oriented transversely to the vertical median plane, and the stud being articulated to the engine.

According to one embodiment, the assembly is remarkable in that the engine comprises a plurality of straight attachment fittings spaced apart from one another and all extending parallel to the median vertical plane and distributed symmetrically on either side of this plane, with a pair of proximal fittings located on either side of the plane and a pair of distal fittings located on either side of the pair of proximal fittings, the shackle, extending in the vertical median plane, being, on the one hand, inserted between the pair of proximal fittings and, on the other hand, between the first pair of branches, on each side of the vertical median plane, a branch of the second pair of branches being located between a fitting of the pair of proximal fittings and a fitting of the pair of distal fittings, the first pivot pin oriented transversely to the vertical median plane passing through the branches of the first pair of branches and the shackle, and the second pivot pin passing through the fittings, the shackle and the branches of the second pair of branches.

According to an advantageous feature, the engine comprises a blind bore located to the rear of the fittings with a bore axis located in the median vertical plane and oriented transversely to the longitudinal axis, the stud being received in the blind bore.

### BRIEF DESCRIPTION OF THE DRAWINGS

The above-mentioned features of the invention, along with others, will become more clearly apparent upon reading the following description of an example of an embodiment, the description being provided with reference to the appended drawings, in which:

FIG. 1 is a side view of an aircraft according to the prior art;

FIG. 2 is a side view of an engine (the nacelle is not shown) mounted beneath a wing of the aircraft in FIG. 1 using an engine mounting pylon;

FIG. 3 is a perspective view of the front of an assembly of an engine mounting pylon and an engine, according to one embodiment of the invention;

FIG. 4 is a view similar to FIG. 3, in which the primary structure of the engine mounting pylon is visible;

FIG. 5 is a front perspective view, in section on the line A-A, of the assembly depicted in FIG. 3;

FIG. 6 is a front perspective view, in section on the line B-B, of the assembly depicted in FIG. 3.

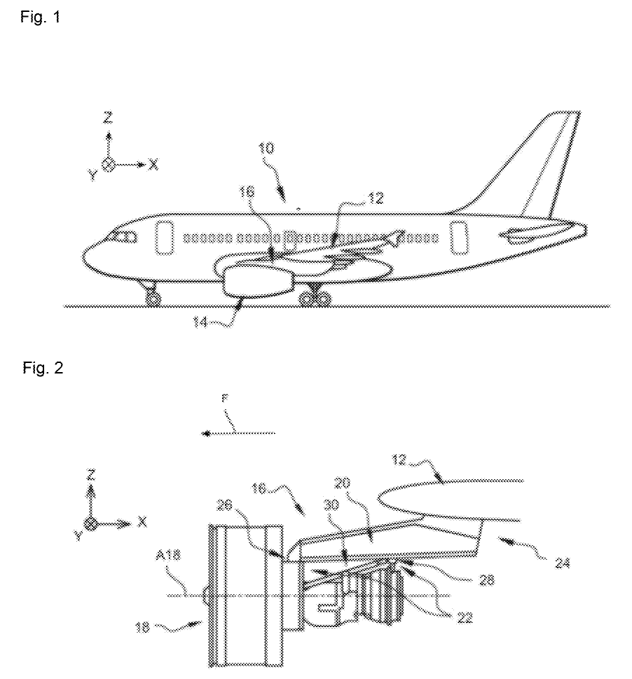

### DETAILED DESCRIPTION OF THE PREFERRED EMBODIMENTS

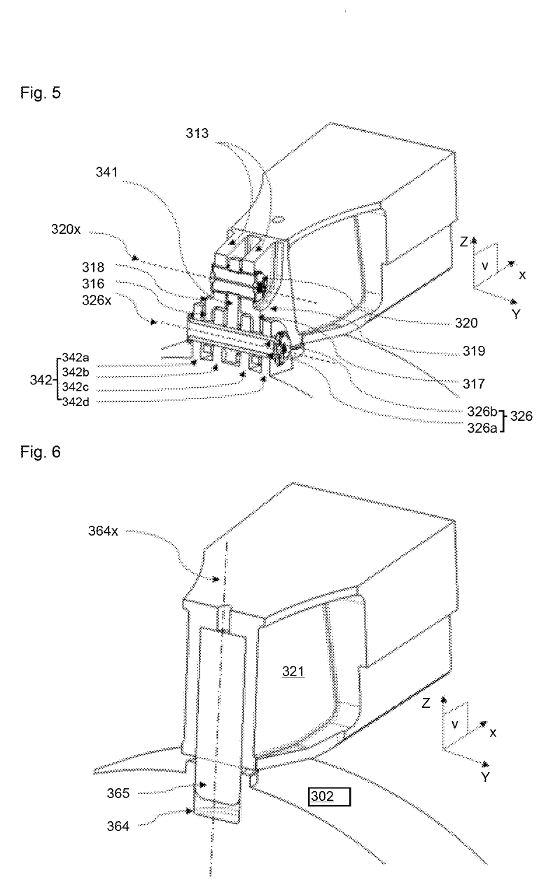

With reference to FIGS. 2 to 6, an engine is attached to an engine mounting pylon 20 using a system of engine mounts 22 comprising a rear engine mount 28 located at the rear of the engine and a front engine mount 26 located at the front of the engine.

By convention, the longitudinal axis of the engine is referred to as X. Moreover, Y denotes the transverse axis of the engine, this axis being horizontal when the aircraft is on the ground, and Z denotes the vertical axis or height when the aircraft is on the ground, these three directions X, Y and Z being mutually orthogonal.

Moreover, the terms “front” and “rear” are to be considered relative to a direction of forward movement of the aircraft when the engine is in operation, this direction being schematically indicated by the arrow F in the figures. Likewise, the terms “port” and “starboard” define lateral positions with respect to the direction of forward movement, these being respectively the left and right sides of the aircraft.

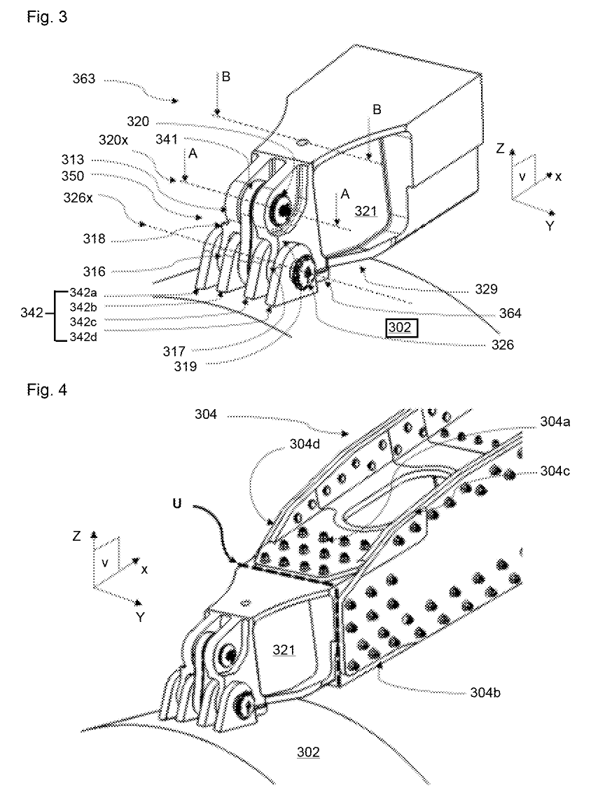

With reference to FIGS. 3 to 6, the engine mounting pylon comprises a primary structure 304 in the form of a hollow box structure extending from front to rear along the longitudinal axis X. The primary structure 304 is separated into two, port-side and starboard-side, parts by a longitudinal median vertical plane V passing through the longitudinal axis X, orthogonal to the ground, in other words orthogonal to the horizontal. The port-side and starboard-side parts of the primary structure 304 are symmetrical to one another about the median vertical plane V.

The primary structure 304 comprises an internal structure (not depicted) covered with panels which include, at the top, a planar upper panel, or upper spar 304a, which forms the upper face of the box structure, and, at the bottom, a planar lower panel, or lower spar 304b, which forms the lower face of the box structure and which faces the ground and the engine 302. The panels further comprise two lateral panels forming the sides of the box structure, these being a planar lateral panel arranged to the port side of the median vertical plane V and referred to as the port-side lateral panel 304c, and a planar lateral panel arranged to the starboard side of the median vertical plane V and referred to as the starboard-side lateral panel 304d. The upper 304a and lower 304b spars and the starboard-side 304d and port-side 304c lateral panels define an opening U on the front face of the primary structure 304.

The rear engine mount 28 is attached, at one location, to the lower spar of the engine mounting pylon 20 and, at another location, to the engine. The rear engine mount 28, which is not the subject matter of the present invention, may have any form known to those skilled in the art and will not be described in any further detail.

As can be seen in particular in FIGS. 3 and 4, the front engine mount 363 is attached, on the one hand, to the engine mounting pylon and, on the other hand, to a set of fittings 342 rigidly secured to the engine 302. The set of fittings 342 is located to the front of the engine mounting pylon/engine assembly, and a housing in the form of a lower blind bore 364 with a bore axis 364x located in the median vertical plane V and oriented transversely to the longitudinal axis X, is made in the engine 302 to the rear of the set of fittings 342.

The set of fittings 342 comprises a plurality of straight attachment fittings spaced apart from one another and all extending parallel to the median vertical plane V and distributed symmetrically on either side of this plane, with a pair of proximal fittings, one starboard-side 342b and the other port-side 342c, located on either side of the plane and a pair of distal fittings, one starboard-side 342a and the other port-side 342d, located on either side of the pair of proximal fittings 342b and 342c. Each of the fittings, both proximal and distal, comprises a through-bore filled with a second pivot 326 discussed below), the bore axis of which is parallel to an axis 326x oriented transversely to the vertical median plane V. The axes of the bores of the various fittings are aligned and coincident with the axis 326x and the bores are substantially identical. Each of the through-bores is fitted with a bushing.

The front engine mount 363 takes the form of a body 321 of generally parallelepiped shape, elongate and extending from front to rear along the longitudinal axis X. The body 321 comprises, at its front end, a front face and, at its rear end, a rear face. The lower face of the body faces the engine.

The body 321 is partially fitted, at its rear end, into the opening U in the primary structure 304. The body 321 extends the primary structure 304 forward.

According to the invention, the body 321 comprises, on its front face and from top to bottom:

a first pair of branches 313 rigidly secured to the body, with branches distributed on either side of the median vertical plane V,

a second pair of branches located below the first pair of branches 313, with a port-side branch 319 and a starboard-side branch 318. The spacing between the branches 318, 319 of the second pair of branches is greater than the spacing between the branches of the first pair of branches 313.

The branches of the first and second pairs of branches all extend parallel to the median vertical plane V, towards the front of the body 321. The branches of the first pair of branches are arranged symmetrically on either side of the median vertical plane V, and the branches of the second pair of branches are located symmetrically on either side of this same plane. The first pair of branches is articulated with the engine by means of a two-point straight shackle 341, articulated, on the one hand, to the body 321 and, on the other hand, to the engine. The shackle 341 comprises a first end inserted between the two branches of the first pair of branches 313 and articulated to the latter, by means of a first pivot pin 320, the bore axis of which is parallel to an axis 320x oriented transversely to the vertical median plane V. The second end of the shackle 341 is inserted between the two proximal fittings of the engine.

The port-side branch 319 of the second pair of branches is inserted between the port-side proximal fitting 342c and the port-side distal fitting 342d and the starboard-side branch 318 of the second pair of branches is inserted between the starboard-side distal fitting 342a and the starboard-side proximal fitting 342b of the set of fittings 342 arranged on the engine.

A pivot pin 326 extends transversely to the vertical median plane V and passes through the set of fittings 342 of the engine, symmetrically on either side of the vertical median plane V, the branches of the second pair of branches and the shackle allowing the articulation of the body 321 to the engine 302.

The assembly made up of the first pair of branches 313, the shackle 341 and the set of fittings 342, the first pivot pin 320 and the second pivot pin 326 makes it possible to absorb the vertical load along the vertical axis Y, coming from the engine when it is in operation.

The body 321 also comprises, on its lower face, a protruding stud 365, which extends along an axis contained in the plane V, transversely to the axis X and projects from the lower face of the body, downwards, in the direction of the engine 302. The stud 365 is inserted, with a tight fit, in the housing 364 made in the engine 302. The tight fit of the stud 365 in the housing 364 makes it possible to absorb the longitudinal and transverse load coming from the engine when it is in operation.

Thus, the first pair of branches 313, the shackle 341, the set of fittings 342, the first pivot pin 320, the second pivot pin 326 and the stud 365 tightly fitted in its housing constitute a primary load-transmission pathway and ensure that the engine mount 363 and the engine 302 are rigidly secured together by blocking three degrees of freedom in a statically determinate manner.

To be more specific as regards the attachment of the body 321 to the fittings of the engine, each end of the shackle 341 is pierced with a through-bore equipped with a swivel bearing.

The first end of the shackle 341 is articulated to the first pair of branches by means of the first pivot pin 320 extending transversely to the vertical median plane V. The pivot pin 320 is pushed into a swivel bearing mounted in a bore made in the first end of the shackle 341 and on either side of this swivel bearing, in a bushing mounted in a bore made in a branch of the first pair of branches. The bores in the branches of the first pair of branches are identical and have a bore axis oriented transversely to the vertical median plane V.

The second end of the shackle 341 is articulated to the set of fittings 342 by means of the pivot pin 326 extending transversely to the vertical median plane V. The pivot pin 326 is pushed into a swivel bearing mounted in a bore made in the second end of the shackle 341 and on either side of this swivel bearing, in the bushings mounted in the bores in the fittings of the set of fittings 342. The pivot pin 326 fits tightly in the bores in the fittings of the set of fittings 342 and with a radial clearance in the bores in the branches 318, 319 of the second pair of branches.

The second pair of branches 318, 319 and the pin 326 provide the secondary load-transmission pathway, which only comes into effect in the event of a complete or partial failure along the first load-transmission pathway.

Thus, in the event of failure of a branch of the first pair of branches 313, of the shackle 341, or of the first pivot pin 320, the load may be absorbed by the second pair of branches 318, 319 and the pin 326, which act as a failsafe.

The pin 326 is a dual pin for the purposes of redundancy, and comprises two coaxial cylindrical parts: 326a, which is referred to as the main pin, and 326b, which is referred to as the secondary pin, which have different diameters. The main pin 326a is in a first engaged position, forming a primary load-transmission pathway in the vertical plane by being a tight fit in its bores, and the secondary pin 326b is on standby and comes into operation to absorb the load if the main pin 326a should break.

The assembly of the engine mounting pylon with an engine according to the invention offers a compact configuration making it possible to absorb this load at the uppermost point on the engine mounting pylon and thus allow the installation of large-diameter fans beneath the wings of the aircraft.

By comparison with the assembly of an engine mounting pylon with an engine according to the prior art, and for an engine and pylon of the same size, measurements have made it possible to establish that the maximum distance between the lower spar of the engine mounting pylon and the engine can be reduced by half with the assembly of an engine mounting pylon with an engine in accordance with the invention.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly of an engine mounting pylon with an aircraft engine, the aircraft engine extending along a longitudinal axis, the engine mounting pylon comprising:
a primary structure extending from front to rear along the longitudinal axis, separated into two, port and starboard, parts by a longitudinal median vertical plane passing through the longitudinal axis, the primary structure comprising:
at the top, an upper spar,
at the bottom, a lower spar located facing the engine,
a front face having an opening,
the assembly comprising:
at the rear, a rear engine mount and,
at the front, a front engine mount, each of the front and rear engine mounts being attached, at one location, to the primary structure and, at another location, to the engine,
wherein the front engine mount comprises a body partially fitted into the primary structure through the opening and extending the primary structure forward, the body comprising on its front face, and from top to bottom, a first pair of branches then a second pair of branches,
wherein a spacing between the branches of the second pair of branches is greater than a spacing between the branches of the first pair of branches, wherein the branches of the two pairs of branches all extend forward and parallel to a median vertical plane, said median vertical plane forming a plane of symmetry for each of the two pairs of branches,
the body comprising:
a lower face facing the engine and a stud located in the vertical median plane and extending away from said lower face,
a two-point straight shackle, inserted between the branches of the first pair of branches, being articulated, at one location, to the body via a first pivot pin and, at another location, to the engine via a second pivot pin, each of the branches of the second pair of branches being articulated to the engine via the second pivot pin, the first and the second pivot pins being oriented transversely to the vertical median plane, and the stud being articulated to the engine.

2. The assembly of an engine mounting pylon with an aircraft engine according to claim 1,
wherein the aircraft engine comprises a plurality of straight attachment fittings spaced apart from one another and all extending parallel to the median vertical plane and distributed symmetrically on either side of the median vertical plane, with a pair of proximal fittings located on either side of the vertical median plane and a pair of distal fittings located on either side of the pair of proximal fittings,
wherein the shackle, extending in the vertical median plane, is, at one location, inserted between the pair of proximal fittings and, at another location, between the first pair of branches, on each side of the vertical median plane,
wherein a branch of the second pair of branches is located between a fitting of the pair of proximal fittings and a fitting of the pair of distal fittings, wherein the first pivot pin is oriented transversely to the vertical median plane passing through the branches of the first pair of branches and the shackle, and the second pivot pin passes through the proximal and distal fittings, the shackle and the branches of the second pair of branches.

3. The assembly of an engine mounting pylon with an aircraft engine according to claim 2, wherein the aircraft engine comprises a blind bore located at a rear of said proximal and distal fittings with a bore axis located in the vertical median plane and oriented transversely to the longitudinal axis, the stud being received in the blind bore.
